(19) United States
(12) Patent Application Publication
(10) Pub. No.: US 2007/0258720 A1
(43) Pub. Date: Nov. 8, 2007

(54) Inter-chip optical communication

(75) Inventors: Jonathan Gorrell, Gainesville, FL (US); Mark Davidson, Florahome, FL (US)

Correspondence Address: DAVIDSON BERQUIST JACKSON & GOWDEY LLP, 4300 WILSON BLVD., 7TH FLOOR, ARLINGTON, VA, 22203, US

(73) Assignee: Virgin Islands Microsystems, Inc., St. Thomas, VI (US)

(21) Appl. No.: 11/418,365

(22) Filed: May 5, 2006

(51) Int. Cl. H04B 10/00

(52) U.S. Cl. 398/140

(57) ABSTRACT

A system includes a plurality of chips, at least one of said chips having transmission circuitry constructed and adapted to emit a signal in the form of electro-magnetic radiation (EMR), said transmission circuitry including one or more nano-resonant structures that emit said EMR when exposed to a beam of charged particles, and at least some of said chips having receiver circuitry constructed and adapted to receive an EMR signal. A connector is constructed and adapted to receive emitted EMR from said at least one of said chips having transmission circuitry and further constructed and adapted to provide data in said EMR emitted by said at least one of said chips to receiver circuitry of at least some others of said plurality of chips.

### CROSS-REFERENCE TO CO-PENDING APPLICATIONS

### RELATED APPLICATIONS

The present invention is related to the following co-pending U.S. patent applications which are all commonly owned with the present application, the entire contents of each of which are incorporated herein by reference:
(1) U.S. patent application Ser. No. 11/302,471, entitled “Coupled Nano-Resonating Energy Emitting Structures,” filed Dec. 14, 2005 [Atty. Docket 2549-0056];
(2) U.S. patent application No. 11/349,963, entitled “Method And Structure For Coupling Two Microcircuits,” filed Feb. 9, 2006 [Atty. Docket 2549-0037];
(3) U.S. patent application Ser. No. 11/238,991 [atty. docket 2549-0003], filed Sep. 30, 2005, entitled “Ultra-Small Resonating Charged Particle Beam Modulator”;
(4) U.S. patent application Ser. No. 10/917,511, filed on Aug. 13, 2004, entitled “Patterning Thin Metal Film by Dry Reactive Ion Etching”
(5) U.S. application Ser. No. 11/203,407, filed on Aug. 15, 2005, entitled “Method Of Patterning Ultra-Small Structures”;
(6) U.S. Application No. 11/243,476 [Atty. Docket 2549-0058], filed on Oct. 5, 2005, entitled “Structures And Methods For Coupling Energy From An Electromagnetic Wave”;
(7) U.S. application Ser. No. 11/243,477 [Atty. Docket 2549-0059], filed on Oct. 5, 2005, entitled “Electron beam induced resonance,”

(8) U.S. application Ser. No. 11/325,448, entitled “Selectable Frequency Light Emitter from Single Metal Layer,” filed Jan. 5, 2006 [Atty. Docket 2549-0060];

(9) U.S. application Ser. No. 11/325,432, entitled, “Matrix Array Display,” filed Jan. 5, 2006 [Atty. Docket 2549-0021],
(10) U.S. application Ser. No. 11/410,905, entitled, “Coupling Light of Light Emitting Resonator to Waveguide,” filed on Apr. 26, 2006 [Atty. Docket 2549-0077];
(11) U.S. application Ser. No. 11/411,120, entitled “Free Space Interchip Communication,” filed on Apr. 26, 2006 [Atty. Docket 2549-0079];

(12) U.S. application Ser. No. 11/410,924 entitled, “Selectable Frequency EMR Emitter,” filed Apr. 26, 2006 [Atty. Docket 2549-0010];

(13) U.S. application Ser. No. 11/______ entitled, “Multiplexed Optical Communication between Chips on A Multi-Chip Module,” filed on even date herewith [atty. docket 2549-0035]; and

(14) U.S. patent application Ser. No. 11/400,280 titled “Resonant Detector for Optical Signals,” filed Apr. 10, 2006, [Atty. Docket No. 2549-0068].

### COPYRIGHT NOTICE

A portion of the disclosure of this patent document contains material which is subject to copyright or mask work protection. The copyright or mask work owner has no objection to the facsimile reproduction by anyone of the patent document or the patent disclosure, as it appears in the Patent and Trademark Office patent file or records, but otherwise reserves all copyright or mask work rights whatsoever.

### FIELD OF THE DISCLOSURE

This relates to electromagnetic radiation (“EMR” devices, and, more particularly, inter-chip communications using EMR.

### INTRODUCTION

Various exemplary EMR-emitting micro-resonant structures have been described in the related applications. For example, U.S. application Ser. No. 11/410,924, entitled, “Selectable Frequency EMR Emitter,” [Atty. Docket 2549-0010] describes various exemplary light-emitting micro-resonant structures. The structures disclosed therein can emit light (such as infrared light, visible light or ultraviolet light or any other electromagnetic radiation (EMR) at a wide range of frequencies, and often at a frequency higher than that of microwave). The EMR is emitted when the resonant structure is exposed to a beam of charged particles ejected from or emitted by a source of charged particles. The source may be controlled by applying a signal on data input. The source can be any desired source of charged particles such as an electron gun, a cathode, an ion source, an electron source from a scanning electron microscope, etc.

It is sometimes desirable to couple the emitted light so as to direct it to some other location. For example, a communications medium (e.g., a fiber optic cable) may be provided in close proximity to the resonant structures such that light emitted from the resonant structures is directed in the direction of a receiver, as is illustrated, e.g., in FIG. 21 of U.S. application Ser. No. 11/410,924, [Atty. Docket 2549-0010].

FIGS. 1-3 of U.S. application Ser. No. 11/______ [atty. docket 2549-0035] show exemplary structures for coupling emitted light.

The related applications, e.g., U.S. application Ser. No. 11/______, entitled, “Multiplexed Optical Communication between Chips on A Multi-Chip Module,” [atty. docket 2549-0035], describes multiplexed optical communication between chips on a so-called multi-chip module (“MCM”) —generally considered to be an integrated circuit package that contains two or more interconnected chips.

It is desirable to use EMR to communicate between chips in separate packages, i.e., between chips that are not necessarily part of a MCM.

### BRIEF DESCRIPTION OF THE DRAWINGS

The following description, given with respect to the attached drawings, may be better understood with reference to the non-limiting examples of the drawings, wherein:

FIGS. 1, 2A-2G, 3-5 are schematic diagrams of example transmitter and receiver circuits;

FIG. 6 shows example logical communication circuitry within a chip; and

FIGS. 7-8 are schematic diagrams of multi-chip communications.

### THE PRESENTLY PREFERRED EXEMPLARY EMBODIMENTS

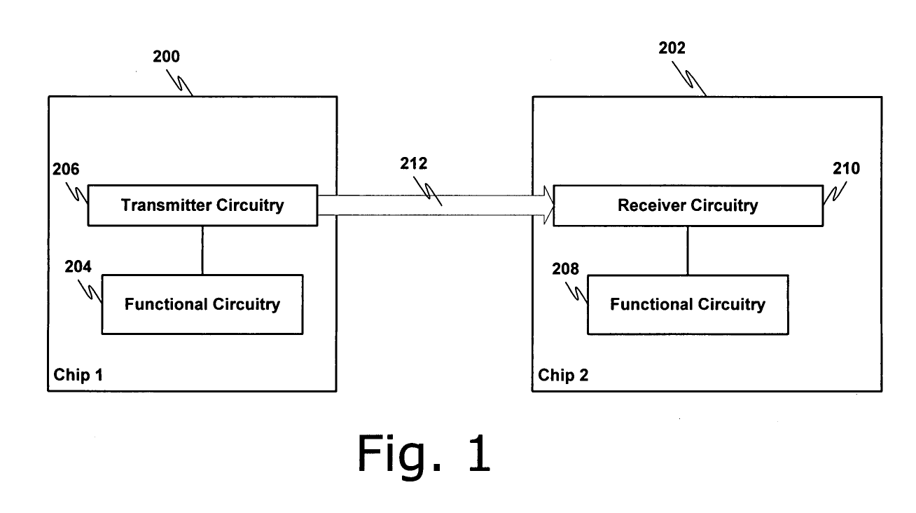

FIG. 1 shows two chips 200, 202. Chip #1 200 includes functional circuitry 204 operationally connected to transmitter circuitry 206. The functional circuitry 204 may comprise one or more circuits that implement the functionality of the chip 200. The transmitter circuitry 206 includes one or more EMR-emitting elements formed from at least one nano-resonant structure that emits EMR (such as infrared light, visible light or ultraviolet light or any other electromagnetic radiation).

As used herein, the term “nano-resonant structure” or its similar variants will refer to structures capable of resonating at microwave frequencies or higher, and which have at least one physical dimension that is less than the wavelength of such resonant frequency.

The EMR is emitted when the nano-resonant structure is exposed to a beam of charged particles ejected from or emitted by a source of charged particles. The charged particle beam can include ions (positive or negative), electrons, protons and the like. The beam may be produced by any source, including, e.g., without limitation an ion gun, a tungsten filament, a cathode, a planar vacuum triode, an electron-impact ionizer, a laser ionizer, a chemical ionizer, a thermal ionizer, an ion-impact ionizer. The various nano-resonant structures are described, e.g., in related applications referred to above and incorporated herein by reference.

Exemplary EMR-emitting elements which are employable herein are described in co-pending and co-owned U.S. patent application Ser. No. 11/325,448, entitled “Selectable Frequency Light Emitter from Single Metal Layer,” filed Jan. 5, 2006 [Atty. Docket 2549-0060], the entire contents of which have been incorporated herein by reference.

Chip #2 202 includes functional circuitry 208 operationally connected to receiver circuitry 210. The functional circuitry 208 may comprise one or more circuits that implement the functionality of the chip 202. The receiver circuitry 210 is constructed and adapted to receive EMR signals, e.g., from transmitter circuitry 206 of chip 200. The receiver circuitry can include any kind of optical receiver capable of receiving EMR. In some embodiments, the receiver circuitry can only receive EMR at certain frequencies. Exemplary receiver circuitry is described in co-pending U.S. application Ser. No. 11/______, entitled, “Multiplexed Optical Communication between Chips on A Multi-Chip Module,” filed on even date herewith [atty. docket 2549-0035], the entire contents of which have been incorporated herein by reference.

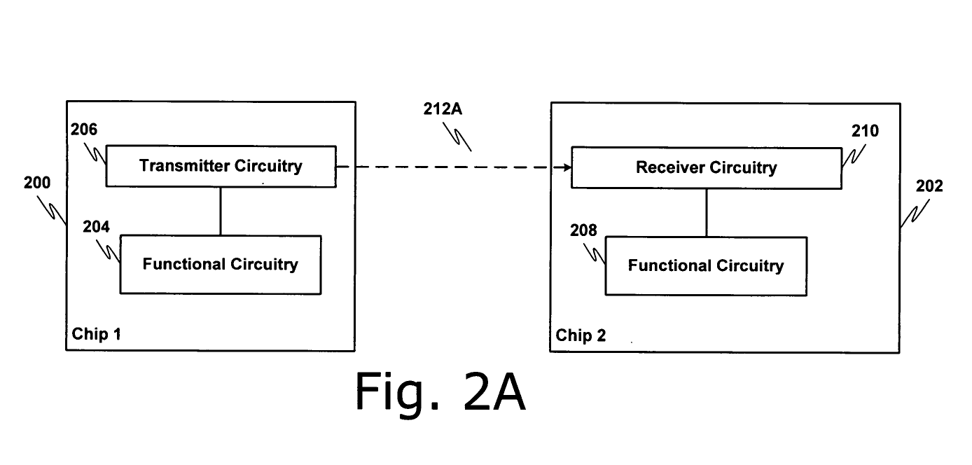

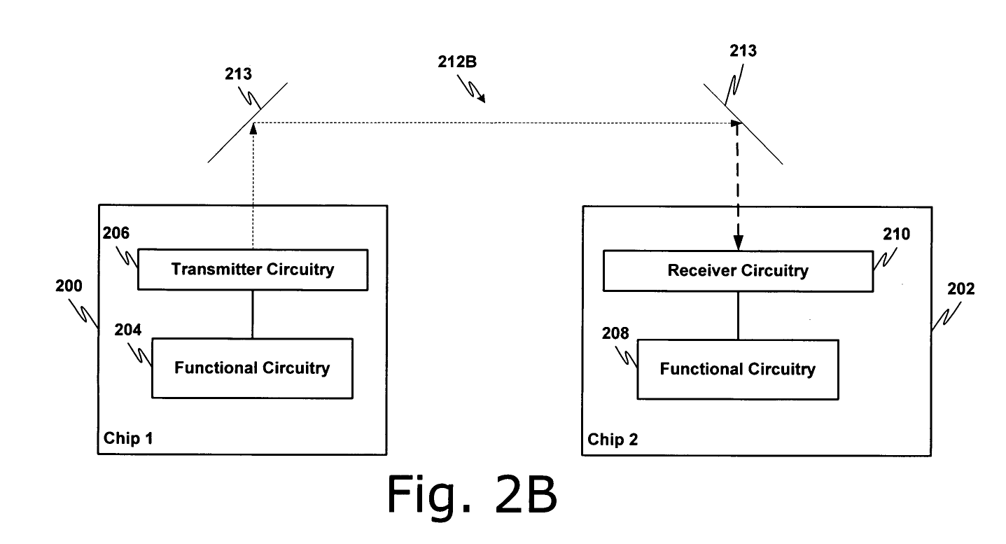

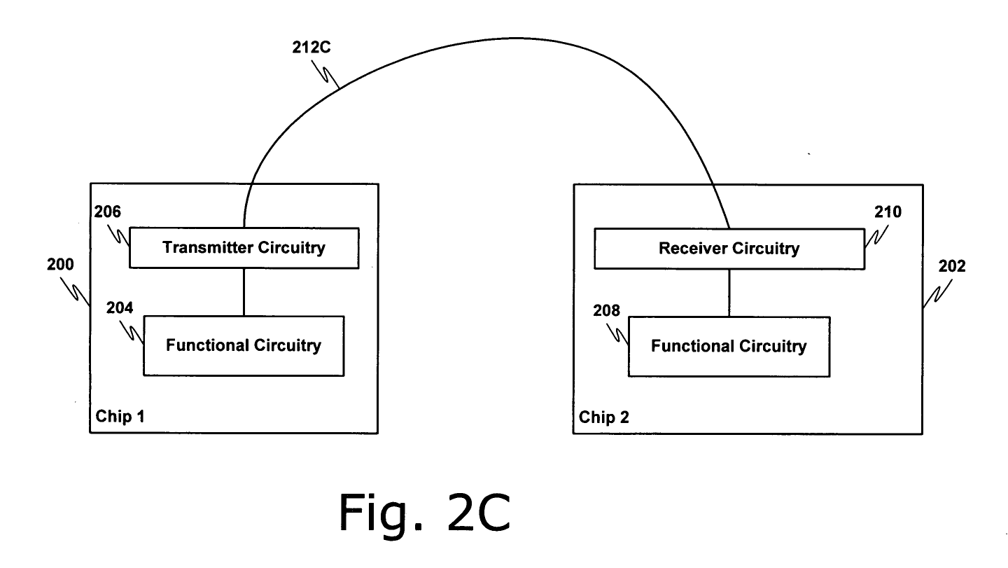

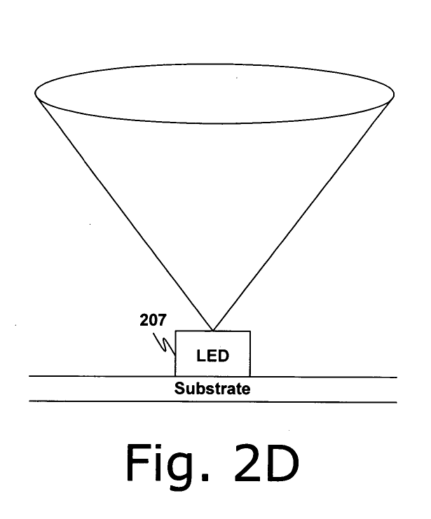

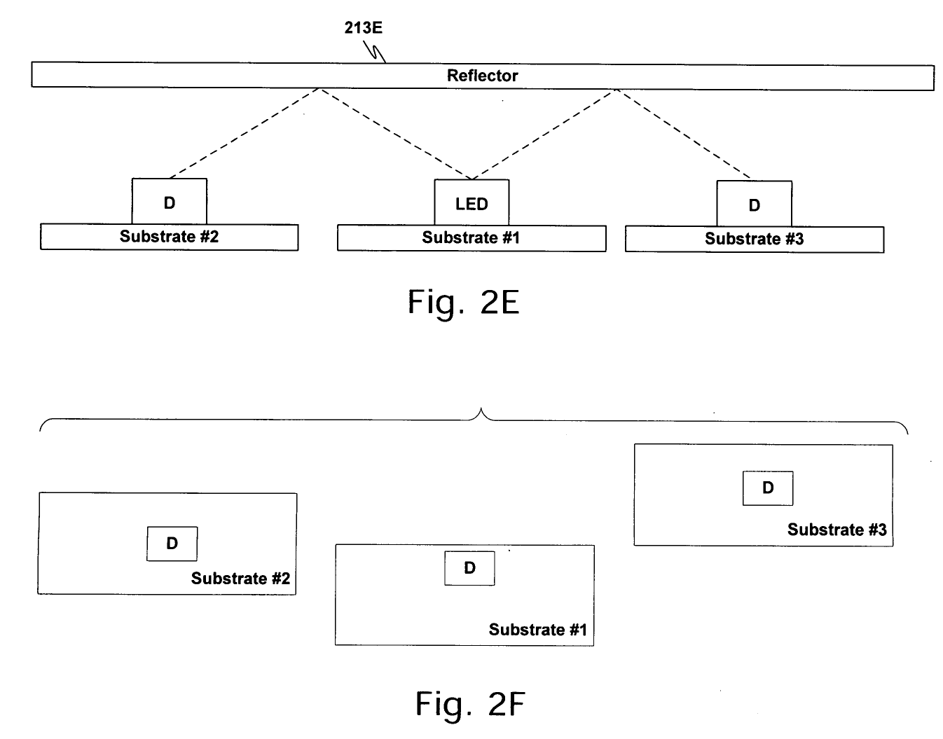

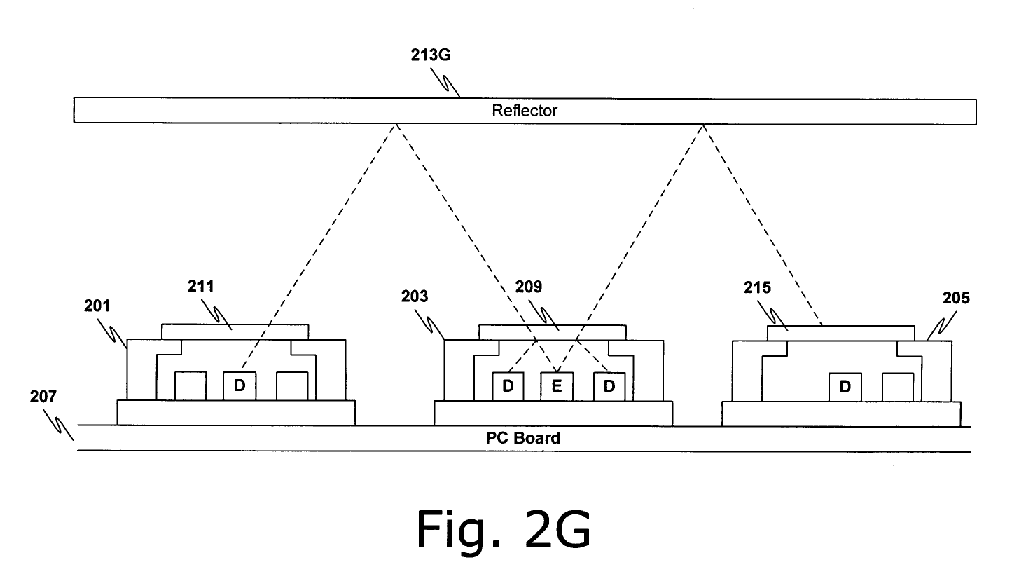

The connection 212 between the two chips 200, 202 may include a fiber optic cable or some other suitable device or mechanism constructed and adapted to provide the data between the two chips. As shown in FIG. 2A, the connection 212A may be formed by a direct line-of-sight connection between the transmitter circuitry 206 (on chip 200) and the receiver circuitry 210 (on chip 202). As shown in FIG. 2B, the connection 212B may include reflective devices such as mirrors 213 or the like positioned between the chips to direct EMR transmitted by the transmitter circuitry 206 (on chip 200) to the receiver circuitry 210 (on chip 202). As shown in FIG. 2C, a fiber optic cable 212C or the like may be used to direct EMR from the transmitter circuitry on the first chip 200 to the receiver circuitry on the second chip 202. Any of the examples of FIGS. 2A-2C can be used together or discretely, in any of the further embodiments described herein.

FIG. 2B shows the EMR being transmitted along the connection 212B (shown by the dashed lines in the drawing). However, as shown in FIG. 2D, a typical EMR emitter (e.g., LED 207) emits radiation in a conical region surrounding the emitter. This allows for configurations of the type shown in FIG. 2E, in which a single reflector 213E is disposed opposite various emitters (LED) and detectors (D). As shown by the dashed lines in FIG. 2E, EMR from the LED on substrate #1, is detected by a detector on substrate #2 and by another detector on substrate #3. In this manner, a circuit on substrate #1 can communicate optically with circuits on other substrates. Since the radiation from the LED is emitted in essentially all directions (as shown in FIG. 2D), the emitter (LED) on substrate #1 can communicate with detectors on substrates in its vicinity. One of skill in the art will thus understand, upon reading this description, that the various substrates (containing circuitry), do not have to laid out in a straight line, and that any layout will be acceptable as long as the light emitted by the emitter can reach the appropriate detector. FIG. 2F shows an exemplary top view layout of the circuit-bearing substrates of FIG. 2E.

The reflectors/mirrors 213, 213E may be used as frequency selectors. That is, the reflectors may be constructed and adapted to pass through certain frequencies and filter out others.

In addition, though not shown in the drawings, each emitter and/or detector may include a lens or other filtering mechanism to perform, inter alia, frequency selection.

FIG. 2G shows a configuration of IC packages 201, 203, 205 (which may include multi-chip modules) positioned on a PC board 207. The packages include emitters (E) and/or detectors (D). For example, IC package 203 includes an emitter E and two detectors D. The IC packages may include windows 209, 211, 215 which can function as reflectors and as band-pass filters. For example, a particular window may allow light of a certain frequencies to be transmitted through the window while it may reflect light of certain frequencies. Thus, with reference to the drawing in FIG. 2G, suppose, e.g., that the emitter E in IC package 203 can emit EMR at frequency A and at frequency B, and window 209 passes light of frequency B and reflects light of frequency B. Suppose too that window 215 of IC package 205 blocks light of frequency B, and that window 211 of IC package 201 allows light of frequency B to pass through. In that exemplary scenario, frequency B can be used for certain intra chip communications (between chips 201 and 203), whereas frequency A can be used for inter-chip communications within chip 203. Those skilled in the art will understand, upon reading this description, that the windows can be used to allow sets or ranges of frequencies for inter-chip communication and sets or ranges of frequencies for intra-chip communications. In some cases, a certain frequency or frequency range can be used to communicate to a cluster or group of chips. For example, if a number of chips each have a window which allows a different frequency in the range α to β, then a transmitter can selectively transmit to one of them by transmitting at the frequency of the desired target's window. A transmitter can also transmit to a larger group (including all) of the chips, but transmitting across the entire frequency range of the chips.

In operation, data generated by functional circuitry 204 on chip 200 are sent to chip 202 via the transmitter circuitry 206 and along the connection 212. On chip 202, the data are received by receiver circuitry 210 and provided, as necessary, to the functional circuitry 208 on chip 202.

For the purposes of explanation, the circuitry of a chip has been logically divided into functional circuitry—i.e., the part circuitry that performs the function of that particular chip—and communications (transmitter and/or receiver) circuitry—i.e., the part of the circuitry that performs the communication. Those of skill in the art will understand and realize that, in implementation, the functional circuitry may overlap with the communications circuitry.

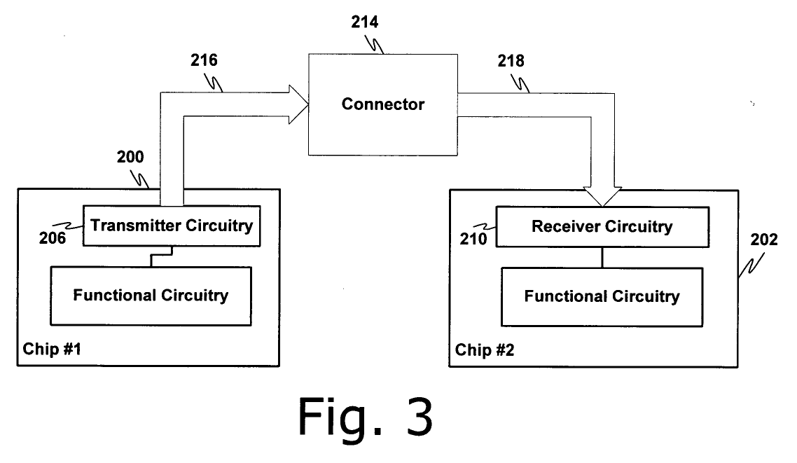

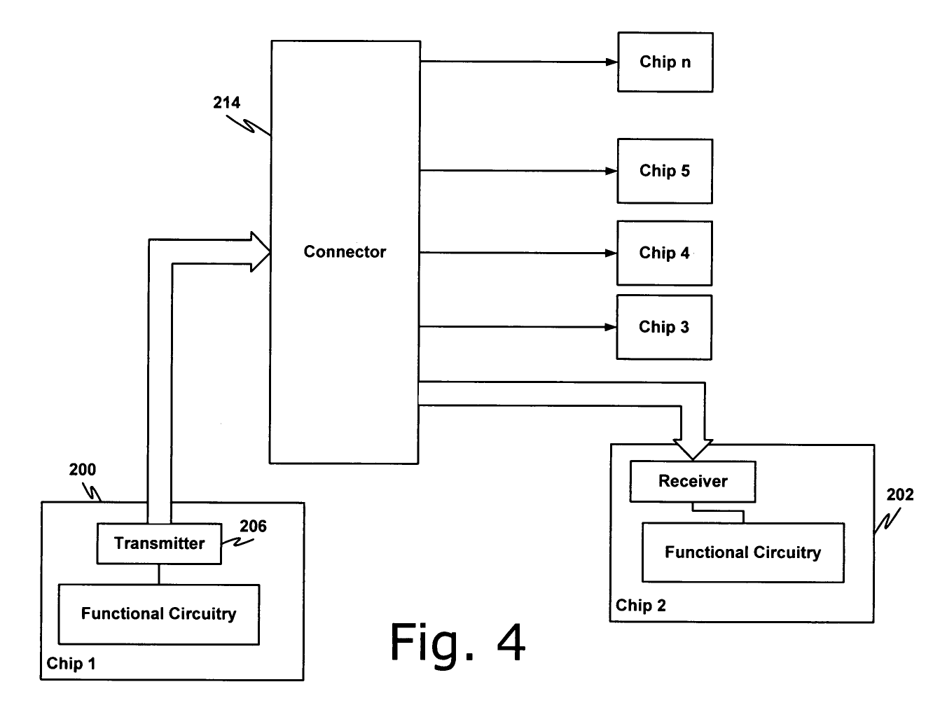

FIG. 1 shows a single chip 200 transmitting data directly to a single chip 202. Data may alternatively be transmitted via one or more intermediate devices. For example, as shown in FIG. 3, data from chip 200 are transmitted to chip 202 via connector 214. The connector 214 may be or include, e.g., circuitry constructed and adapted to receive data from one chip (in this case chip 200) and to re-transmit or re-direct those data to one or more other chips (in this case to chip 202). Connector 214 may be an optical switch or multiplexer. In FIG. 3, the connector 214 transmits data from chip 202 to one or more chips (chip 2, chip 3, . . . , chip n). Each of the receiving chips has appropriate circuitry constructed and adapted to receive the data transmitted by the connector 214.

The connection 216 between chip #1 200 and the connector 214 may be direct (line-of-sight), via one or more reflective devices (e.g., mirrors and the like), via a fiber optic connection or by some other mechanism. Similarly, the connection 218 between the connector 214 and the receiver circuitry 210 in the second chip 202 may be direct (line-of-sight), via one or more reflective devices (e.g., mirrors and the like), via a fiber optic connection or by some other mechanism. In addition, one of the two connections may be non-optical (e.g., electrical). Those skilled in the art will realize that there is no need for connection 214 and connection 218 to be of the same type—any combination of the types of connections are contemplated by this invention. E.g., one connection could be line-of-sight while the other could be a fiber optic connection.

Generally, the fiction of the connector is to provide signals from one or more sources to one or more destinations. The connector may simply retransmit or redirect the EMR it receives. In this sense, the mirrors or reflective devices described above with reference to FIG. 2B may be considered to form a connector.

In some embodiments, connector 214 may retransmit the data using EMR of a different wavelength and/or frequency. In some embodiments, the connector 214 may receive data in one form (e.g., as EMR from chip 200) along connection/path 216, and retransmit or send the data in a different form (e.g., electrically) along connection/path 218 to chip 202. In this manner, connector 214 may act to convert data from optical to electrical form or vice versa.

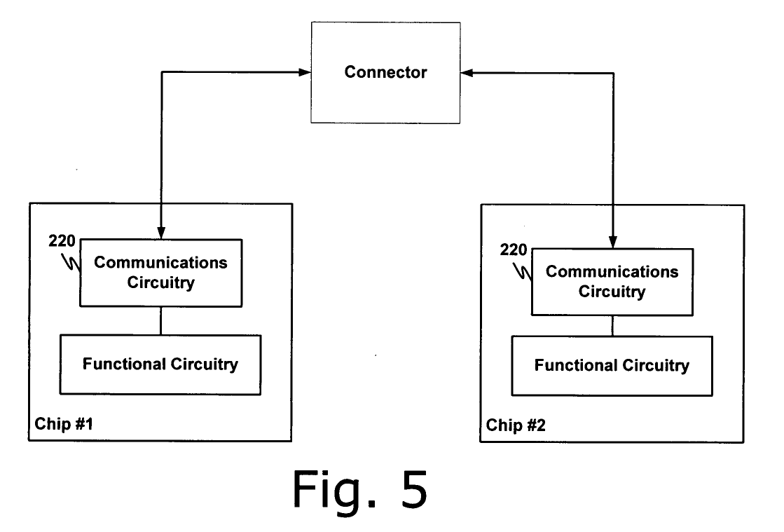

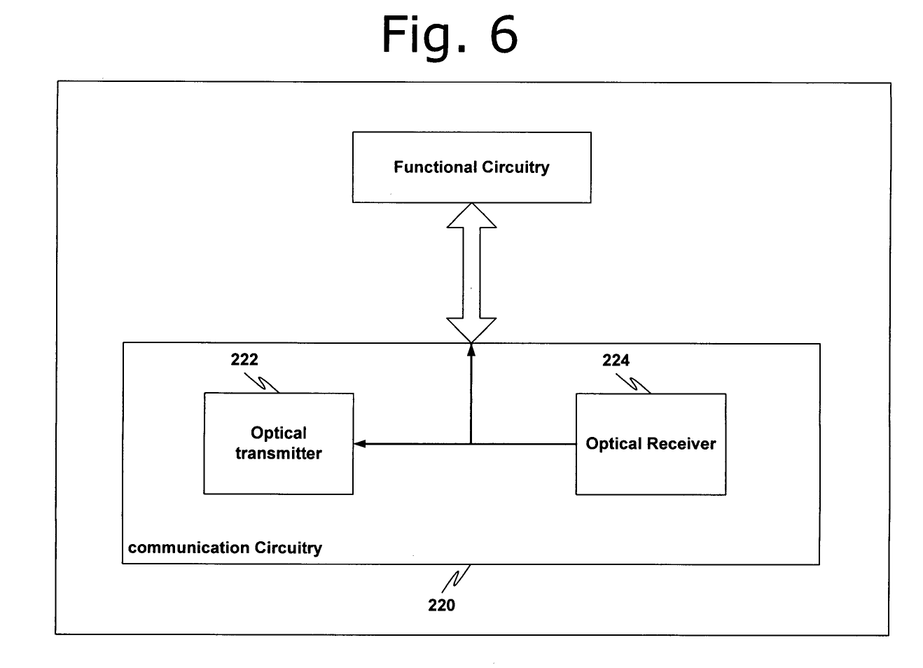

The description thus far has shown each chip with either transmitter circuitry or receiver circuitry. Those skilled in the art will realize that each chip may have both receiver and transmitter circuitry (generally referred to as communication circuitry), as shown in FIG. 5. In addition, a chip may have communication circuitry to transmit and/or receive to/from more than one other chip or device. Connector 214 thus may be considered, in some cases, to be a chip with one or more receivers and one or more transmitters. As shown in FIG. 6, the communications circuitry 220 consists, in presently preferred embodiments, of an optical transmitter 222 and an optical receiver 224, each operationally and functionally connected to the functional circuitry of the chip, so that data from the chip can be sent via optical transmitter 222, and data coming in to the chip can be received by the optical receiver 224. It will be understood by those of skill in the art, as noted above, that a particular IC may not have or require both receiver circuitry and transmitter circuitry.

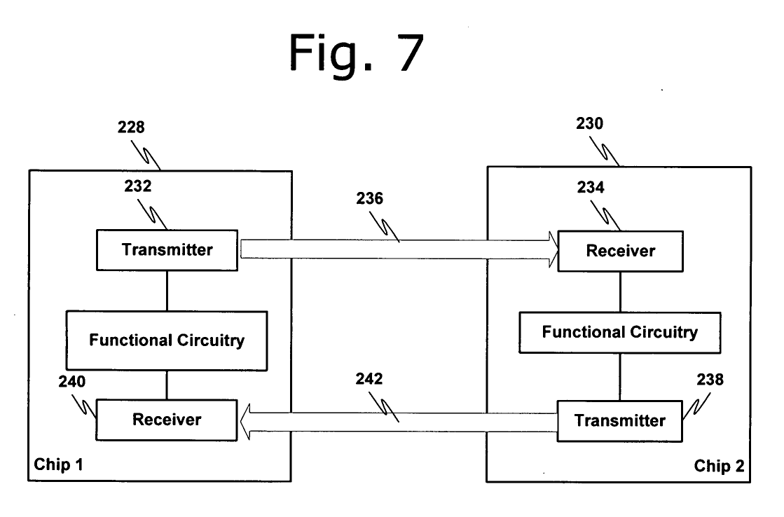

FIG. 7 shows an example of two chips 228, 230 communicating according to embodiments of the present invention. As shown in the drawing, each chip has transmitter and receiver circuitry. The transmitter 232 in chip 228 communicates with the receiver 234 in chip 230 along the connection/path 236. The transmitter 238 in chip 230 communicates with the receiver 240 in the chip 228 via the connection/path 242. The connections/paths 236, 242 may be of the same type and formed along the same physical path (e.g., line-of-sight, fiber optic, via connection mechanism, etc.), or each may be of a different type or along different physical connections. E.g., connection 242 may be a fiber optic cable whereas connection 236 may be a direct line-of-sight connection. All possible combinations of connections are contemplated by the invention.

As described in the co-pending and co-owned U.S. patent application Ser. No. 11/______ [Atty. docket 2549-0035], the optical transmitter may be formed by one or more nano-resonant structures and the optical receiver may be formed, e.g., as described in U.S. patent application Ser. No. 11/400,280, filed Apr. 10, 2006, titled “Resonant Detector For Optical Signals,” [Atty. Docket No. 2549-0068] or by any well-known light receiver. Output from the optical receiver is provided to the functional circuitry.

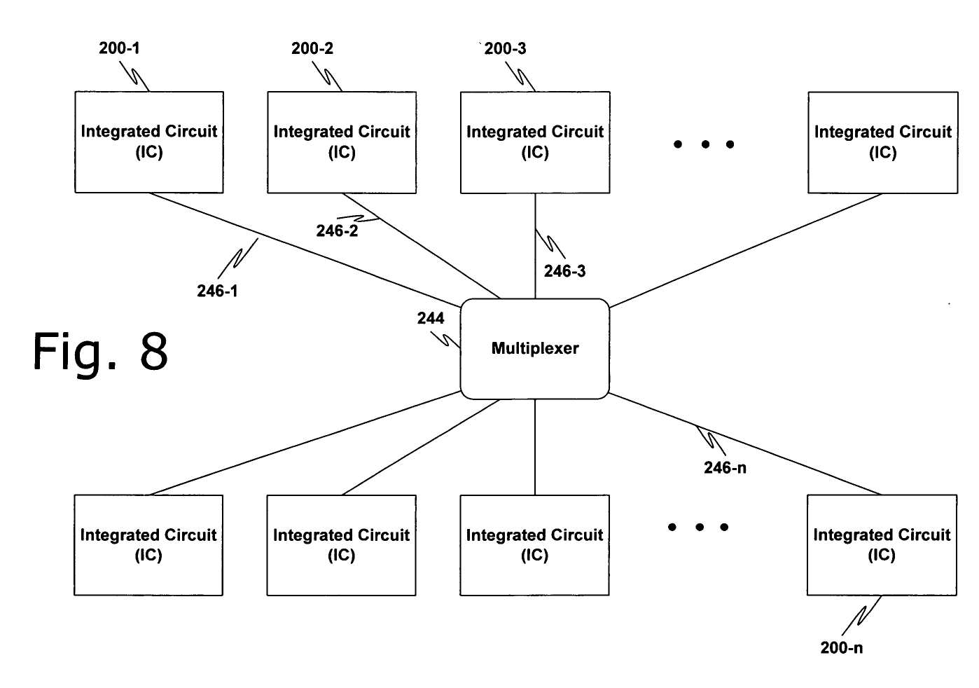

FIG. 8 show another example, in this case where multiple chips are communicating. As shown in the drawing, the chips 200-1, 200-2, 200-3, . . . , 200-n (generally denoted 200-j) communicate optically via multiplexer 244. The multiplexer 244 may be considered to be a special case of the connector 214 shown in FIG. 3. Each chip 200-j communicates with the multiplexer 244 via a communications path/connection 246-j. Thus, for example, as shown in the drawing, chip 200-1 communicates with the multiplexer 244 via communications path/connection 246-1.

Each communications path/connection 246-j may be, e.g., line-of-sight, fiber optic, via connection mechanism, etc. There is no requirement that all paths/connections be of the same form. E.g., some can be line-of-sight while others use fiber optic connections. Some of the chips may only transmit data via the multiplexer, some of the chips may only receive data via the multiplexer, and some of the chips may transmit and receive data via the multiplexer. Those skilled in the art will understand that each chip may connect to other chips (shown or not shown) via other connection paths and/or mechanisms. The multiplexer may be selectively switched or the destination of data may be determined based, e.g., on a wavelength or frequency of EMR received by the multiplexer.

The devices according to embodiments of the present invention may be made, e.g., using techniques such as described in U.S. patent application Ser. No. 10/917,511, entitled “Patterning Thin Metal Film by Dry Reactive Ion Etching” and/or U.S. application Ser. No. 11/203,407, entitled “Method Of Patterning Ultra-Small Structures,” both of which have been incorporated herein by reference. The nano-resonant structure may comprise any number of resonant microstructures constructed and adapted to produce EMR, e.g., as described above and/or in U.S. application Ser. No. 11/325,448, entitled “Selectable Frequency Light Emitter from Single Metal Layer,” filed Jan. 5, 2006 [Atty. Docket 2549-0060], U.S. application Ser. No. 11/325,432, entitled, “Matrix Array Display,” filed Jan. 5, 2006, and U.S. application Ser. No. 11/243,476 [Atty. Docket 2549-0058], filed on Oct. 5, 2005, entitled “Structures And Methods For Coupling Energy From An Electromagnetic Wave”; U.S. application No. 11/243,477 [Atty. Docket 2549-0059], filed on Oct. 5, 2005, entitled “Electron beam induced resonance;” and U.S. application Ser. No. 11/302,471, entitled “Coupled Nano-Resonating Energy Emitting Structures,” filed Dec. 14, 2005 [atty. docket 2549-0056].

Various light-emitting resonator structures have been disclosed, e.g., in the related applications listed above. The word “light” referring generally to any electromagnetic radiation (EMR) at a wide range of frequencies, regardless of whether it is visible to the human eye, including, e.g., infrared light, visible light or ultraviolet light. It is desirable to couple such produced light into a waveguide, thereby allowing the light to be directed along a specific path.

While certain configurations of structures have been illustrated for the purposes of presenting the basic structures of the present invention, one of ordinary skill in the art will appreciate that other variations are possible which would still fall within the scope of the appended claims. While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A system comprising:
a first chip having transmission circuitry constructed and adapted to emit a signal in the form of electromagnetic radiation (EMR), said transmission circuitry including one or more nano-resonant structures that emit said EMR when exposed to a beam of charged particles; and
a second chip having receiver circuitry constructed and adapted receive said emitted EMR.

2. A system as in claim 1 wherein said second chip is physically adjacent said first chip.

3. A system as in claim 1 wherein said emitted EMR travels from said first chip to said second chip along a direct line-of-sight optical path.

4. A system as in claim 1 wherein said emitted EMR travels from said first chip to said second chip along an indirect optical path.

5. A system as in claim 4 wherein said indirect optical path includes one or more reflective elements.

6. A system as in claim 1 wherein said emitted EMR travels from said first chip to said second chip along a fiber optic path.

7. A system as in claim 1 further comprising:
a connector mechanism constructed and adapted to provide to the second chip data transmitted from the first chip.

8. A system as in claim 7 wherein the connector mechanism receives said data from the first chip in a first form and transmits the received data to the second chip in a second form distinct from the first form.

9. A system as in claim 8 wherein the first form comprises EMR at a first wavelength and/or frequency and wherein the second form comprises EMR at a second wavelength and/or frequency distinct from the first wavelength and/or frequency.

10. A system as in claim 7 wherein the connector mechanism is connected to the first chip in a first connection form and is connected to the second chip in a second connection form distinct from the first connection form.

11. A system as in claim 10 wherein the first and second connection forms are selected from the group comprising: optical connection; electrical connection.

12. A system comprising:
a plurality of chips, at least one of said chips having transmission circuitry constructed and adapted to emit a signal in the form of electromagnetic radiation (EMR), said transmission circuitry including one or more nano-resonant structures that emit said EMR when exposed to a beam of charged particles;
a connector constructed and adapted to receive said emitted EMR and to provide data in said EMR emitted by said at least one of said chips to at least some others of said plurality of chips.

13. A system as in claim 12 wherein:
said connector comprises circuitry constructed and adapted to receive said emitted EMR from said at least one chip and to retransmit said EMR signal to others of said plurality of chips.

14. A system as in claim 13 wherein said connector is further constructed and adapted to selectively retransmit said EMR signal to one or more of said plurality of chips.

15. A system as in claim 12 wherein said connector is optically connected to at least some of said plurality of chips.

16. A system as in claim 6 wherein the at least on nano-resonant structure is constructed and adapted to emit at least one of visible light, infrared light, and ultraviolet light.

17. A system comprising:
a plurality of chips, at least one of said chips having transmission circuitry constructed and adapted to emit a signal in the form of electromagnetic radiation (EMR), said transmission circuitry including one or more nano-resonant structures that emit said EMR when exposed to a beam of charged particles, and at least some of said chips having receiver circuitry constructed and adapted to receive an EMR signal; and
a connector constructed and adapted to receive emitted EMR from said at least one of said chips having transmission circuitry and further constructed and adapted to provide data in said EMR emitted by said at least one of said chips to receiver circuitry of at least some others of said plurality of chips.

18. A system as in claim 17 wherein the connector is optically connected to at least some of said plurality of chips.

19. A system as in claim 18 wherein at least some of said plurality of chips are optically connected to said connector along a direct line-of-sight optical path.

20. A system as in claim 18 wherein at least some of said plurality of chips are optically connected to said connector along an indirect optical path.

21. A system as in claim 18 wherein said indirect optical path includes one or more reflective devices.

22. A system as in claim 17 wherein the connector mechanism receives data from in a first form and transmits the received data in a second form distinct from the first form.

23. A system as in claim 22 wherein the first form comprises EMR at a first wavelength and/or frequency and wherein the second form comprises EMR at a second wavelength and/or frequency distinct from the first wavelength and/or frequency.

24. A system as in claim 16 wherein at least one of the chips comprises:
a source of charged particles.

25. A system as in claim 24 wherein said source of charged particles is selected from the group comprising:
an ion gun, a tungsten filament, a cathode, a planar vacuum triode, an electron-impact ionizer, a laser ionizer, a chemical ionizer, a thermal ionizer, and an ion-impact ionizer.

26. A system as in claim 24 wherein the charged particles are selected from the group comprising: positive ions, negative ions, electrons, and protons.

27. A system comprising:
a plurality of integrated chips; and
an optical multiplexer,
wherein at least some of the chips are optically interconnected via the optical multiplexer, and
wherein at least some of the chips comprise:
at least one nano-resonant structure constructed and adapted to emit electromagnetic radiation (EMR) in response to excitation by a beam of charged particles.

28. A method comprising:
providing a first chip having transmission circuitry constructed and adapted to emit a signal in the form of electromagnetic radiation (EMR), said transmission circuitry including one or more nano-resonant structures that emit said EMR when exposed to a beam of charged particles; and
providing a second chip having receiver circuitry constructed and adapted receive said emitted EMR.

29. A method as in claim 28 further comprising:
providing said second chip physically adjacent said first chip.

30. A method as in claim 28 further comprising:
causing said first chip to emit an EMR signal; and
causing said emitted EMR signal to be provided to said second chip.

31. A method as in claim 30 wherein said emitted EMR travels from said first chip to said second chip along an indirect optical path.

32. A method as in claim 31 wherein said indirect optical path includes one or more reflective elements.

33. A method as in claim 30 wherein said emitted EMR travels from said first chip to said second chip along a fiber optic path.

34. A method as in claim 28 further comprising:
providing a connector mechanism constructed and adapted to provide to the second chip data transmitted from the first chip.

35. A method as in claim 34 further comprising:
at the connector mechanism, receiving data from the first chip in a first form; and
transmitting the received data to the second chip in a second form distinct from the first form.
